(19) United States
(12) Patent Application Publication
(10) Pub. No.: US 2023/0198870 A1
(43) Pub. Date: Jun. 22, 2023

(54) Packet Capture Device and Packet Capture Method

(71) Applicant: Nippon Telegraph and Telephone Corporation, Tokyo (JP)

(72) Inventors: Namiko Ikeda, Tokyo (JP); Hiroyuki Uzawa, Tokyo (JP); Koyo Nitta, Tokyo (JP); Yuta Ukon, Tokyo (JP); Shuhei Yoshida, Tokyo (JP); Yusuke Sekihara, Tokyo (JP); Shoko Oteru, Tokyo (JP)

(21) Appl. No.: 17/925,698

(22) PCT Filed: May 26, 2020
(86) PCT No.: PCT/JP2020/020707

§ 371 Date: Nov. 16, 2022

(51) Int. Cl. H04L 43/028; H04L 43/04; H04L 47/125

(52) U.S. Cl. CPC H04L 43/028; H04L 43/04; H04L 47/125

(57) ABSTRACT

A packet capture apparatus includes a hardware processing unit including a filter that filters packets input from a network and an NIC and a packet storage that stores packets input from the hardware processing unit. The filter includes a packet input that receives packets input from the network, a header analysis unit that analyzes a header structure of each packet input to the packet input unit and extracts a field value of a header of the packet, a rule table in which rules including a field value of a flow to be captured are recorded, a flow identification unit that identifies a flow in which the field value extracted by the header analysis unit matches a rule in the rule table and/or does not match the rule, and a packet output that outputs a packet of the flow identified by the flow identification unit to the NIC.

### CROSS-REFERENCE TO RELATED APPLICATIONS

This application is a national phase entry of PCT Application No. PCT/JP2020/020707, filed on May 26, 2020, which application is hereby incorporated herein by reference.

### TECHNICAL FIELD

The present invention relates to a packet capture technique for verifying and analyzing a network.

### BACKGROUND

In order to monitor and verify various networks, it is necessary to capture and analyze packets flowing in a target network. In the capturing, it is required to limit packets to be captured in order to reduce a packet storage area and reduce a load on an analysis apparatus.

As a general high-performance system that can support a high-speed network and also has a filtering function, there is a capture apparatus made of dedicated hardware, but it is very expensive (see, for example, NPL 1).

Here, as a general method, there is a method in which a packet filter unit is provided in a server and packets that match a set rule are extracted in software and stored in a packet storage unit as illustrated in FIG. 10. However, because this method involves performing processing in software, it is difficult to deal with a high-speed network. There is also a method of capturing all packets and performing filtering, but due to software processing, it is still difficult to deal with a high-speed network and a large capacity is required for a storage unit.

Further, various attacks have occurred in networks in recent years and there is an increasing demand for analysis of packets other than highly reliable packets. A load on an analysis apparatus at a subsequent stage can also be reduced and cost can be reduced if only highly malicious packets with unknown field values, which are difficult to predict, can be output, but this has not been realized in the related art.

### CITATION LIST

### Non Patent Literature

NPL 1: “SYNESIS, 100G Packet Capture System,” [online], [retrieved on May 22, 2020], Internet <URL: https://www.synthesis.tech/>

### SUMMARY

### Technical Problem

In the related art, it is difficult to realize an economical capture system capable of dealing with a high-speed network as described above. Further, there is a problem that it is difficult to perform analysis of packets other than highly reliable packets as has been demanded in recent years.

Embodiments of the present invention have been made to solve the above problems and it is an object of embodiments of the present invention to provide a capture system capable of achieving both economy and high speed.

### Means for Solving the Problem

In order to achieve the object, a packet capture apparatus of embodiments of the present invention includes a hardware processing unit that includes a filter unit and a Network Interface Controller (NIC) unit, the filter unit being configured to filter packets input from a network; and a packet storage unit configured to store packets input from the hardware processing unit. The filter unit includes: a packet input unit configured to receive packets input from the network; a header analysis unit configured to analyze a header structure of each packet input to the packet input unit and extract a field value of a header of the packet; a rule table in which at least one rule including a field value of a flow to be captured is recorded; a flow identification unit configured to identify a flow in which the field value extracted by the header analysis unit matches the at least one rule and/or does not match the at least one rule; and a packet output unit configured to output a packet of the flow identified by the flow identification unit to the NIC unit.

In order to achieve the object, a packet capture method of embodiments of the present invention is a packet capture method performed by a packet capture apparatus including a hardware processing unit that includes a filter unit and an NIC unit, the filter unit being configured to filter packets input from a network, and a packet storage unit configured to store packets input from the hardware processing unit. The packet capture method includes: receiving, by the filter unit, packets input from a network; analyzing, by the filter unit, a header structure of each received packet and extracting, by the filter unit, a field value of the packet; identifying, by the filter unit, a flow in which the extracted field value matches and/or does not match a field value of a flow to be captured; and outputting, by the filter unit, a packet of the identified flow.

### Effects of Embodiments of the Invention

According to embodiments of the present invention, it is possible to provide a capture system capable of achieving both economy and high speed.

### BRIEF DESCRIPTION OF THE DRAWINGS

FIG. 1 is a block diagram illustrating a configuration of a traffic monitoring apparatus according to a first embodiment of the present invention.

FIG. 2 is a block diagram illustrating a configuration of a filter unit according to the first embodiment of the present invention.

FIG. 3 is a flowchart illustrating an operation procedure of a packet capture method according to the first embodiment of the present invention.

FIG. 4 is a block diagram illustrating a configuration of a filter unit according to a second embodiment of the present invention.

FIG. 5 is a block diagram illustrating a configuration of an NIC unit according to a third embodiment of the present invention.

FIG. 6 is a block diagram illustrating a configuration of a packet capture apparatus according to the third embodiment of the present invention.

FIG. 7 is a block diagram illustrating a configuration of a filter unit according to the third embodiment of the present invention.

FIG. 8 is a diagram for explaining header conversion according to the third embodiment of the present invention.

FIG. 9 is a block diagram illustrating a configuration of a packet capture apparatus according to a fourth embodiment of the present invention.

FIG. 10 is a block diagram illustrating a configuration of a packet capture apparatus in the related art.

### DETAILED DESCRIPTION OF ILLUSTRATIVE EMBODIMENTS

Hereinafter, embodiments of the present invention will be described in detail with reference to the drawings. The present invention is not limited to the following embodiments.

### First Embodiment

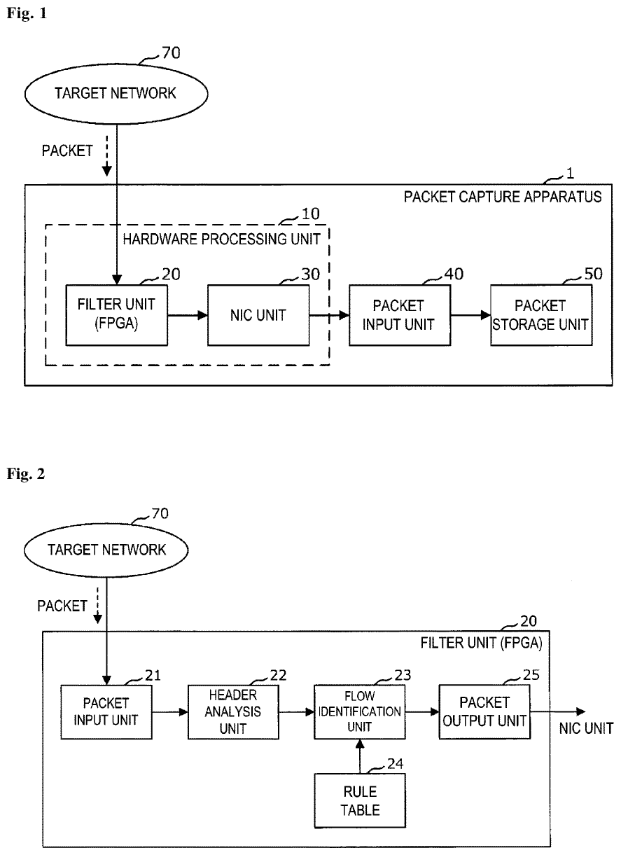

A first embodiment of the present invention will be described. FIG. 1 is a block diagram illustrating a configuration of a traffic monitoring apparatus according to the first embodiment of the present invention.

A packet capture apparatus 1 includes a hardware processing unit 10, which includes a filter unit 20 for filtering packets input from a network 70 to be monitored and verified and a network interface card (NIC) unit 30, a packet input unit 40 which receives packets input from the hardware processing unit 10, and a packet storage unit 50 that stores packets. The filter unit 20 is implemented in a field programmable gate array (FPGA).

In the packet capture apparatus 1, packets input from the network 70 to be monitored and verified are input to the filter unit 20 implemented in the FPGA. The filter unit 20 is equipped with a function of filtering packets to be captured and outputs the filtered packets to the NIC unit 30. The packet input unit 40 outputs packets input from the NIC unit 30 to the packet storage unit 50 and the packets to be monitored are stored in the packet storage unit 50.

FIG. 2 is a block diagram illustrating a configuration of a filter unit according to the first embodiment. In the filter unit 20, a packet input unit 21 receives each packet input from the network 70 to be monitored and verified and outputs the input packet to a header analysis unit 22. The header analysis unit 22 analyzes a header structure of the packet to extract field values such as a MAC address and an IP address.

One or a plurality of rules for identifying a flow to be captured, that is, a set of packets corresponding to the same rule including a field value of a packet, are recorded in a rule table 24. A flow identification unit 23 compares a field value input from the header analysis unit 22 with one or a plurality of rules recorded in advance in the rule table 24 to identify a packet to be captured and outputs the identified packet to a packet output unit 25. The packet output unit 25 outputs the packet input from the flow identification unit 23 to the NIC unit 30.

Here, the flow identification unit 23 may be configured to identify packets that match a rule in the rule table 24 or may be configured to identify packets that do not match a rule. Further, the flow identification unit 23 may be configured to be able to identify a flow based on a rule that combines matching/mismatching rules such that it outputs packets that match one rule and do not match another rule.

As a rule for identifying packets in the rule table 24, a specific field value may be used as a wildcard (which is, at any value, determined to be a match) or packets may be captured from a target network to automatically create a rule.

### Operation of Traffic Monitoring Method

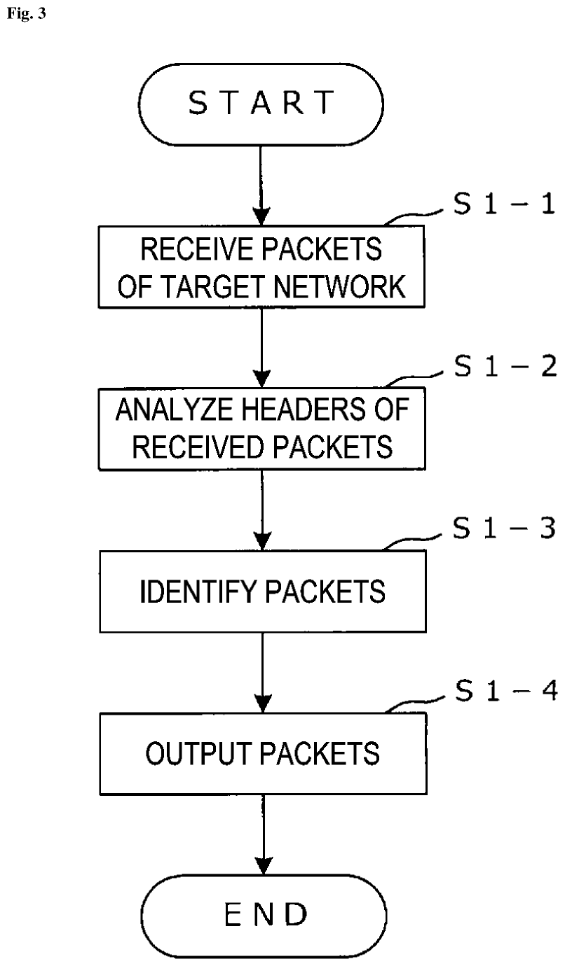

An operation of a packet capture method according to the first embodiment will be described with reference to FIG. 3. FIG. 3 is a flowchart illustrating an operation procedure of the packet capture method according to the first embodiment of the present invention.

When a packet has been input from the network to be monitored and verified (step S1-1), header analysis of the input packet is performed to extract header information (step S1-2).

Next, a header extracted through the header analysis is compared with a rule for a flow to be captured to identify a flow that matches or does not match the rule (step S1-3). Packets of the identified flow are output to the NIC unit (step S1-4).

In the present embodiment, a filtering process in high-load packet capture processing is implemented in an FPGA to perform hardware processing, thereby realizing high-speed capture processing. Because the filtering function is implemented in the FPGA, it is possible to flexibly change filtering conditions such as a field value to be analyzed according to the target network. Flexibly changing the filtering conditions can reduce the capacity of memory and the input bandwidth of the NIC unit for capturing packets, thereby achieving cost reduction.

### Second Embodiment

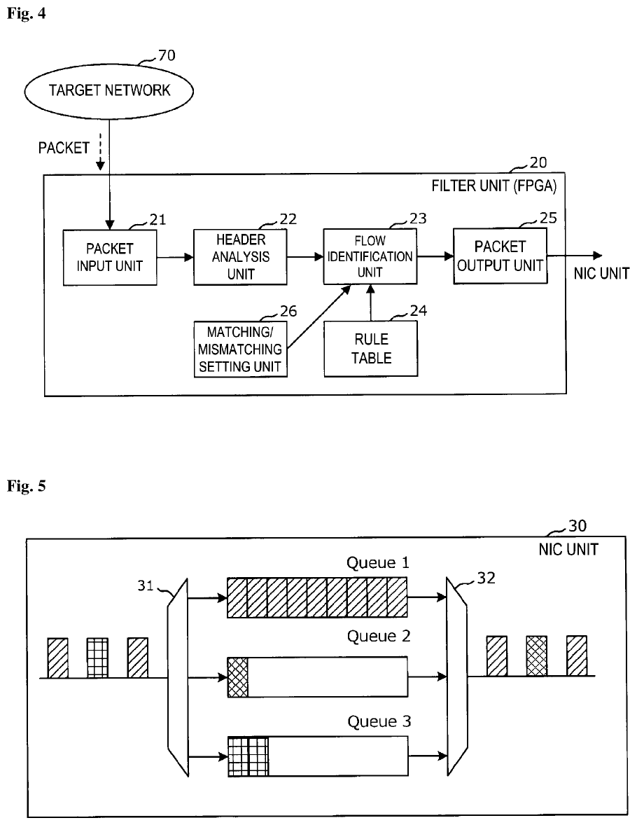

FIG. 4 is a block diagram illustrating a configuration of a filter unit according to a second embodiment of the present invention. In the second embodiment, a matching/mismatching setting unit 26 is added to the filter unit 20 of the first embodiment.

The matching/mismatching setting unit 26 has a function of setting a condition for the flow identification unit 23, such as that as to whether to identify packets that match a rule recorded in the rule table 24 or to identify packets that do not match a rule. This enables, for example, a process of outputting only abnormal packets other than flows whose security is guaranteed.

Here, setting of the matching/mismatching condition may be implemented such that it is uniformly set for all rules in the rule table 24 or may be implemented such that it is set individually for each rule in the rule table 24.

A condition that combines matching/mismatching with a plurality of rules can also be set. For example, it is possible to output packets whose “IP address is other than A” and whose “Mac address is B” by setting “mismatching with rule #1” and “matching with rule #2” through the matching/mismatching setting unit 26 when “IP address=A” has been registered for rule #1 in the rule table 24 and “Mac address=B” has been registered for rule #2.

Further, it is possible to output only either a packet whose “IP address is other than A” or a packet whose “Mac address is B” when “mismatching with rule #1” or “matching with rule #2” has been set. It is also possible to set a condition such as “matching with rule #1 and matching with rule #2” or “mismatching with rule #3 and matching with rule #4”.

Further, a detailed rule can also be set for each field. For example, a detailed condition such as “matching with the Mac address and port number of rule #1 and matching with the IP address of rule #2” or “mismatching with the port number of rule #3 and mismatching with the IP address of rule #4” can also be set.

By enabling such detailed rule setting, for example, by setting a rule of “matching with VLAN=A and mismatching with IP=B” when an abnormality has occurred in VLAN=A and the security of IP=B is guaranteed, it is possible to capture and analyze packets other than IP=B in VLAN=A.

According to the present embodiment, the filter unit 20 can output only a minimum number of packets suspected of being abnormal because highly malicious packets are often a small number of packets. Outputting packets other than those for which security is guaranteed also reduces the number of packets to be analyzed, thus enabling efficient packet analysis. Because the number of packets output from the filter unit 20 can be minimized, the capacity of memory and the input bandwidth of the NIC unit can be reduced, packet loss can be prevented, and cost reduction can be achieved.

Although a configuration in which the matching/mismatching setting unit 26 is separately provided in the filter unit 20 has been described with reference to FIG. 4, the filter unit 20 can also be configured such that the two modes of matching and mismatching are implemented in the flow identification unit 23 without separately providing the matching/mismatching setting unit 26. The filter unit 20 can also be configured to uniformly output captures that match a rule or output packets that do not match a rule by switching the matching and mismatching modes.

### Third Embodiment

A general NIC unit 30 with reduced cost is configured to distribute packets to a plurality of queues (Queues 1 to 3) according to specific field values in headers of the packets. In the exemplary configuration of the NIC unit in FIG. 5, the NIC unit is configured such that packets are distributed to the plurality of queues (Queues 1 to 3) through a demultiplexing unit 31 and are then multiplexed by a multiplexing unit 32.

Here, if the same value is often used for field values of headers, packets may sometimes be concentrated in one queue of the NIC unit as in Queue 1 in FIG. 5, depending on the network service. If packets are concentrated in one queue, packet analysis on a high-speed network may be difficult.

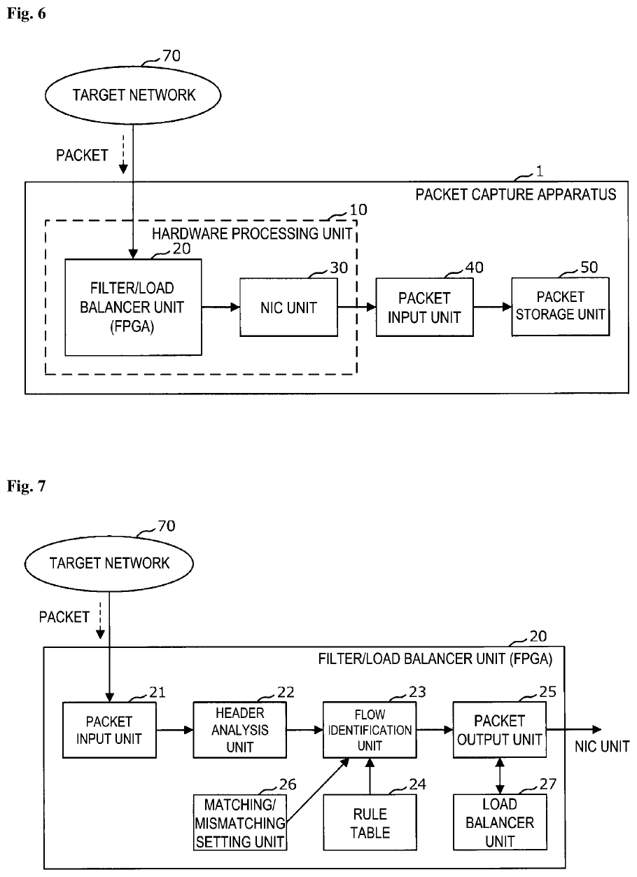

In a third embodiment, the filter unit 20 of the first and second embodiments is configured to have a load balancing function for distributing the load of packets in order to cope with such a situation. FIG. 6 is an exemplary configuration of the packet capture apparatus 1 in which the load balancer function is added to the filter unit 20 of FIG. 1. FIG. 7 illustrates a load balancer unit 27 added to the filter unit 20 of FIG. 4. Similarly, a load balancer function may be added to the filter unit 20 of FIG. 2.

For example, the load balancer unit 27 compares a field value of a packet output from the flow identification unit 23 with a field value of a previously output packet, and if the field values are the same, instructs the packet output unit 25 to convert the field value of the packet output from the flow identification unit 23 to a different value. This configuration can avoid concentration of packets in a specific queue of the NIC unit 30.

The comparison of field values of packets is, for example, comparison of a field value of a packet output from the flow identification unit 23 and a “field value before conversion” of a packet that has been output immediately before.

In order to make distribution to the plurality of queues more even, the load balancer unit 27 may be configured to compare the field value with both a “field value before conversion” and a “field value after conversion” of a previously output packet and convert the field value if the field value is the same as either one of the two field values. The load balancer unit 27 may also be configured to compare the field value with those of all N packets before, where N is an integer of 2 or more, and convert the field value if there is any packet with the same field value among them.

Conditions other than the above can also be set as conditions for converting the field value. For example, a method of rewriting the field value when a greater number of packets than a preset threshold with the same field value have been input among packets that have been input during a certain period or among a predetermined number of packets that have been input or other methods may be adopted.

Various conversion methods can also be set as the field value conversion method. For example, a random value may be added to the field value or one or both of the field value before conversion and time information may be added to the packet and then output from the packet output unit to the NIC unit 30.

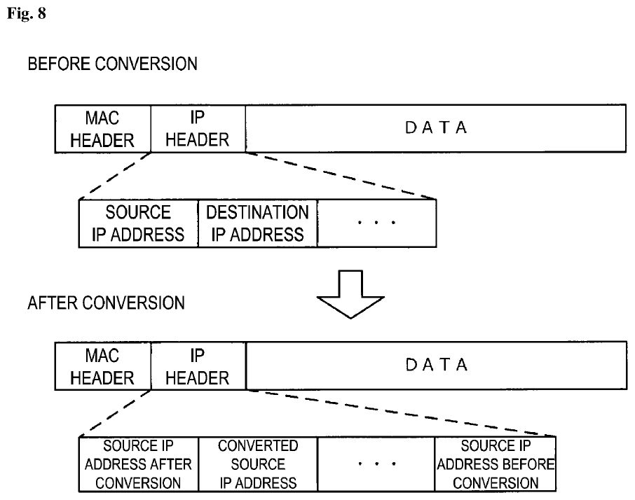

Here, as illustrated in FIG. 8, the load balancer unit 27 may also be configured to replace a source IP address in an IP header with a converted source IP address and store the source IP address before conversion or time information in an option area in the IP header. The source IP address before conversion or the time information may also be stored in a DATA area of the packet.

After the distribution to the plurality of queues by the NIC unit 30, the information given by the load balancer unit 27 (the source IP address before conversion or the time information) may be deleted by the packet input unit 40 or the like.

When the time information has been given, the input order can be checked using the time information during analysis and can also be replaced with the original order. When the load balancer unit 27 is configured to give either the “field value before conversion” or “time information,” information to be given can be reduced.

NIC units with high-speed input capability are generally expensive. In the present embodiment, because the filter unit 20 is equipped with a load balancer function, packets can be captured from a high-speed network without loss even when an NIC unit with reduced cost is used, by distributing an input to a plurality of queues of the NIC unit 30. In the present embodiment, because the filter unit 20 is implemented in an FPGA, a condition for performing the load balancer such as a field value can be easily changed according to the target network.

### Fourth Embodiment

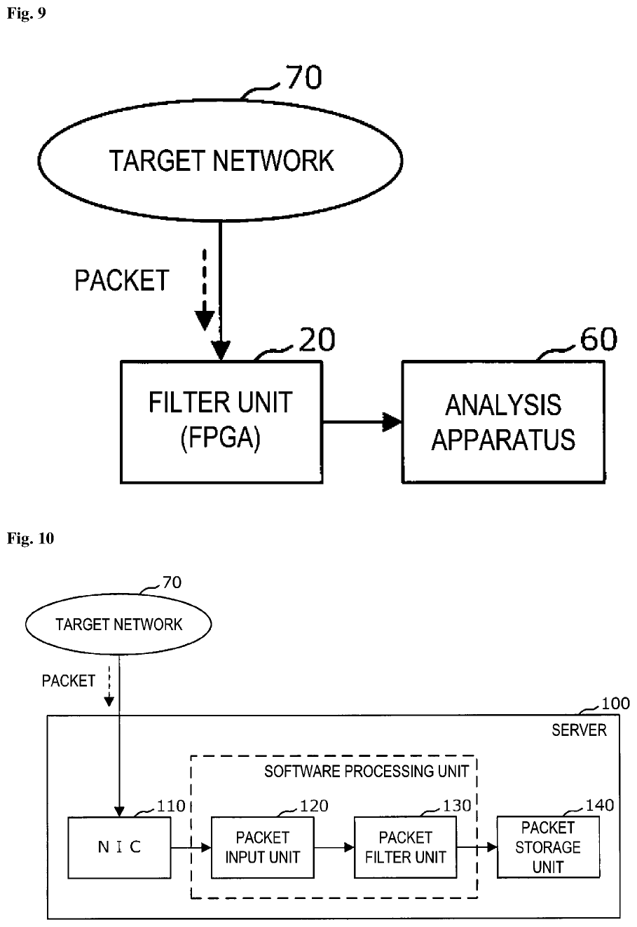

FIG. 9 is a block diagram illustrating a configuration of a packet capture apparatus according to a fourth embodiment of the present invention. The present embodiment is configured such that packets are output from the filter unit 20 of the first to third embodiments described above to an analysis apparatus 60 such as a deep packet injection (DPI).

The filter unit 20 of the above embodiments can output only specific packets suspected of being abnormal or highly malicious packets whose field values are unknown, which require analysis, and thus can reduce the input bandwidth of the analysis apparatus 60. Although the analysis apparatus 60 with high-speed input capability is generally expensive, it is possible to reduce the cost and deal with a high-speed network by adopting the filter unit 20 of the present embodiment.

According to the embodiments of the present invention, a high-load filtering process is implemented in an FPGA to realize it through hardware processing, such that it is possible to realize capture processing that achieves both high speed and economy as described above.

If the FPGA is configured to output only packets that do not match a rule, it is possible to capture only highly malicious packets with field values which are difficult to predict. The storage capacity of captured packets can be reduced because the number of highly malicious packets is often small. The input bandwidth and processing load of the NIC unit or the analysis apparatus connected to the FPGA can be reduced, packet loss can be prevented, and required performance can be reduced, such that the cost of the NIC unit or the analysis apparatus can be reduced.

Further, by providing a load balancer function, the packet filtering process can deal with a high-speed network even when an NIC unit with reduced cost is used. Because the high-load filtering process is implemented in the FPGA, filter conditions of a field to be analyzed, load balancer conditions, and the like can be easily changed according to the target network.

### Expansion of Embodiments

Although the present invention has been described above with reference to the embodiments, the present invention is not limited to the above embodiments. Various modifications that can be understood by those skilled in the art can be made to the configurations of the present invention within the scope of the present invention.

### REFERENCE SIGNS LIST

1 Packet capture apparatus

10 Hardware processing unit

20 Filter unit

21 Packet input unit

22 Header analysis unit

23 Flow identification unit

24 Rule table

25 Packet output unit

30 NIC unit

40 Packet input unit

50 Packet storage unit

70 Network.

1.-5. (canceled)

6. A packet capture apparatus comprising:
a hardware processor comprising a filter and a Network Interface Controller (NIC), the filter being configured to filter packets input from a network; and
a packet storage configured to store packets input from the hardware processor,
wherein the filter includes:
a packet input configured to receive the packets input from the network;
a header analyzer configured to analyze a header structure of each of the packets input from the network and extract a field value of a header of each of the packets input from the network;
a rule table in which at least one rule including a field value of a flow to be captured is recorded;
a flow identifier configured to identify a first flow in which a first field value extracted by the header analyzer matches the at least one rule or does not match the at least one rule; and
a packet output configured to output a packet of the first flow identified by the flow identifier to the NIC.

7. The packet capture apparatus according to claim 6, further comprising a matching/mismatching setting circuit configured to set the flow identifier to identify a flow in which an extracted field value matches the at least one rule or to identify a flow in which an extracted field value does not match the at least one rule.

8. The packet capture apparatus according to claim 6, further comprising a load balancer configured to rewrite the first field value of a first packet that the packet output outputs to the NIC.

9. The packet capture apparatus according to claim 8, wherein at distribution of packets to a plurality of queues based on field values by the NIC, the load balancer is configured to convert the first field value of the first packet output by the packet output to a different field value in response to a detection that the first field value of the first packet is the same as a second field value of a previously output packet.

10. The packet capture apparatus according to claim 8, wherein the field value of the header of each of the packets that is extracted by the header analyzer is a MAC address or an IP address.

11. A packet capture method performed by a packet capture apparatus including a hardware processor that includes a filter and a Network Interface Controller (NIC), the filter being configured to filter packets input from a network, and a packet storage configured to store packets input from the hardware processor, the packet capture method comprising:
receiving, by the filter, packets input from a network;
analyzing, by the filter, a header structure of each of the packets input from the network;
extracting, by the filter, a field value of each of the packets input from the network;
identifying, by the filter, a first flow in which a first field value matches or does not match a field value of a flow to be captured; and
outputting, by the filter, a packet of the first flow.

12. The packet capture method according to claim 11, further comprising setting whether to identify a flow in which an extracted field value matches the at least one rule or to identify a flow in which an extracted field value does not match the at least one rule.

13. The packet capture method according to claim 11, further comprising rewriting the first field value of a first packet that the packet output outputs to the NIC.

14. The packet capture method according to claim 13, wherein at distribution of packets to a plurality of queues based on field values by the NIC, the method further comprises converting the first field value of the first packet to a different field value in response to a detection that the first field value of the first packet is the same as a second field value of a previously output packet.

15. The packet capture method according to claim 11, wherein extracting, by the filter, the field value of each of the packets input from the network comprises extracting a MAC address or an IP address of each of the packets input from the network.
